(19) United States
(12) Patent Application Publication
(10) Pub. No.: US 2025/0389216 A1
(43) Pub. Date: Dec. 25, 2025

(54) VACUUM FURNACE EXHAUST TRAPS AND SYSTEMS

(71) Applicant: Rolls-Royce High Temperature Composites, Inc., Cypress, CA (US)

(72) Inventors: Kai Xin, Cypress, CA (US); Sajan Singh Virdi, Cypress, CA (US)

(21) Appl. No.: 18/753,337

(22) Filed: Jun. 25, 2024

(51) Int. Cl. F01N 3/022

(52) U.S. Cl. CPC F01N 3/0226; F01N 2330/10

(57) ABSTRACT

An exhaust trap configured to filter an exhaust stream of a vacuum furnace may include a housing and a media barrier. The housing defines an interior. The media barrier may divide the interior of the housing into a first chamber and a second chamber and is configured to allow the exhaust stream to flow from the first chamber to the second chamber. The exhaust trap may further include a filter medium in the first chamber and configured to filter the exhaust stream. No filter medium is present in the second chamber.

### TECHNICAL FIELD

The disclosure relates to exhaust traps and exhaust systems for vacuum furnaces.

### BACKGROUND

High-temperature vacuum furnaces are used in melt-infiltration processes, for example, for fabricating ceramic matrix composite materials. An exhaust stream of a vacuum furnace may be extracted by a pump coupled to an outlet of the vacuum furnace. The exhaust stream may include one or more of gas, vapor, aerosolized liquids, droplets, or other products, byproducts, or remnants resulting from a melt-infiltration process.

### SUMMARY

The disclosure describes exhaust traps and exhaust systems including exhaust traps for vacuum furnaces. An exhaust trap may include a filter medium to filter an exhaust stream generated by a vacuum furnace, for example, prior to being pumped by a vacuum pump. For example, the filter medium may reduce or prevent contaminants, particulates, aerosols, or droplets from entering the vacuum pump. An exhaust trap consisting of a single chamber with the filter medium placed in the single chamber may be susceptible to clogging. For example, in course of operation, a pressure spike across the exhaust system and the chamber may continue to increase as the filter medium gets clogged, and eventually, the pressure spike may resist efficient exhausting of the exhaust stream through the exhaust trap. In some examples, the disclosure describes exhaust traps including two chambers, with a filter medium positioned in a first chamber of the two chambers, while a second chamber of the two chamber is in fluid communication with the first chamber, but absent filter medium (e.g., no having contact of filter medium with an outlet of the second chamber or of the exhaust trap). Thus, clogging of the system or of an outlet of the system may be prevented or reduced because accumulated material may be received or collected in the second chamber, while the filter medium continues to exhibit pass-through of the exhaust stream.

In some examples, the disclosure describes an exhaust trap configured to filter an exhaust stream of a vacuum furnace. The exhaust trap may include a housing and a media barrier. The housing defines an interior. The media barrier may divide the interior of the housing into a first chamber and a second chamber and is configured to allow the exhaust stream to flow from the first chamber to the second chamber. The exhaust trap may further include a filter medium in the first chamber and configured to filter the exhaust stream. No filter medium is present in the second chamber.

In some examples, the disclosure describes a system configured to filter an exhaust stream of a vacuum furnace. The system may include a first exhaust trap, a second exhaust trap, and a valve. The exhaust first trap may include a first housing, a first trap inlet, a media barrier, a first filter medium, and a first trap outlet. The first housing may define a first interior. The first trap inlet is configured to receive at least a first portion of exhaust from the exhaust stream into the first interior. The media barrier divides the interior of the first housing into a first chamber and a second chamber and is configured to allow the exhaust stream to flow from the first chamber to the second chamber. The first filter medium is configured to filter the first portion of the exhaust stream received in the first chamber. No filter medium is present in the second chamber. The first trap outlet is configured to discharge a first filtered stream from the first trap. The second exhaust trap may include a second housing, a second trap inlet, a second filter medium, and a second trap outlet. The second housing may define a second interior. The second trap inlet is configured to receive at least a second portion of exhaust from the exhaust stream into the second interior. The second filter medium is configured to filter the second portion of the exhaust stream received in the second interior. The second trap outlet is configured to discharge a second filtered stream from the second trap. The valve is coupled to the second exhaust trap and configured to bypass at least the second portion of the exhaust from the exhaust stream through the second exhaust trap.

The details of one or more examples are set forth in the accompanying drawings and the description below. Other features, objects, and advantages will be apparent from the description and drawings, and from the claims.

### BRIEF DESCRIPTION OF DRAWINGS

FIG. 1A is a conceptual diagram illustrating a top view of an exhaust trap for a vacuum furnace.

FIG. 1B is a conceptual diagram illustrating a cross-sectional view of the exhaust trap at line A-A including a filter medium in a first chamber, and with no filter medium in a second chamber.

FIG. 1C is a conceptual diagram illustrating a disassembled configuration of the exhaust trap with the first chamber separated from the second chamber.

FIG. 2 is a conceptual diagram illustrating a system configured to filter an exhaust stream of a vacuum furnace and including the exhaust trap of FIG. 1A as a first exhaust trap, and a second exhaust trap along a bypass line.

FIG. 3 is a conceptual diagram illustrating a system configured to filter an exhaust stream of a vacuum furnace and including a first exhaust trap, a second exhaust trap, and a third exhaust trap.

### DETAILED DESCRIPTION

The disclosure generally describes exhaust traps and exhaust systems for vacuum furnaces, for example, for filtering an exhaust stream of a vacuum furnace pumped out from the furnace.

The vacuum furnace may be one used in any suitable process for processing any suitable material. In some examples, the vacuum furnace is a high-temperature vacuum furnace used to perform a melt infiltration process to prepare a ceramic matrix composite. An exhaust stream of a vacuum furnace used to perform a process may include one or more process byproducts. When the exhaust stream is filtered, for example, by an exhaust trap, deposition or accumulation of process byproducts in a filter medium of the exhaust trap may lead to a high pressure and/or blocked exhaust line. Such a condition may result in over-pressure alarms during runs at high temperatures, which may result in system downtime for investigation and maintenance. Moreover, a portion of byproduct that exceeds the capacity of the blocked or saturated filter medium may make its way into downstream equipment, for example, a vacuum pump, and affect operation, integrity, and life of such downstream equipment.

In some examples, the disclosure describes an exhaust trap configured to filter an exhaust stream of a vacuum furnace. The exhaust trap may include a housing and a media barrier. The housing defines an interior. The media barrier may divide the interior of the housing into a first chamber and a second chamber and is configured to allow the exhaust stream to flow from the first chamber to the second chamber. The exhaust trap may further include a filter medium in the first chamber and configured to filter the exhaust stream. No filter medium is present in the second chamber. The combination of filter medium present in the first chamber and being absent from the second chamber may promote capture of byproduct, debris, or contaminants in the filter medium, yet substantially maintaining or permitting flow of the exhaust stream through the exhaust trap.

In some examples, the first chamber is separable from the second chamber. For example, the first chamber may be a top section of the exhaust trap relative to a direction of gravity, and include a filter medium (e.g., a fiberglass filter), while the second chamber may be a bottom section of the exhaust trap relative to the direction of gravity. The second chamber may be separated from the filter medium by a media barrier (e.g., a mesh or a screen), and include an empty space (e.g., absent of filter medium) configured to receive and accumulate liquified byproduct debris, leaving an outlet of the exhaust trap substantially free of debris.

In some examples, an exhaust system may include the exhaust trap including an inlet configured to receive at least a portion of an exhaust stream from a vacuum furnace, and further include a bypass line. In some such examples, the exhaust trap is a first exhaust trap, and the bypass line is coupled to a second exhaust trap (e.g., being the same or differing in size, operational principles, structure, or composition from the first exhaust trap). One or more valves may be used to direct at least a portion of the exhaust stream to one or both of the first exhaust trap or the second exhaust trap. For example, the bypass line (e.g., with the second exhaust trap being the same or different in filtration design as the first exhaust trap) may be used as a backup line, and opened if the flow path through the first exhaust trap is pressurized from blockage to allow the exhaust line to flow freely. One or more valves may be operated manually or automatically to direct at least a portion of the exhaust stream to one or both of the first exhaust trap or the second exhaust trap (or to a bypass line or additional exhaust traps) based on operational conditions. The valve may be a ball valve, a pneumatic valve configured to automatically open at a predetermined pressure, or any other suitable valve. Thus, exhaust traps and exhaust systems according to the present disclosure may reduce or prevent clogging of vacuum furnace exhaust lines and passing of product debris to downstream equipment (e.g., a vacuum pump).

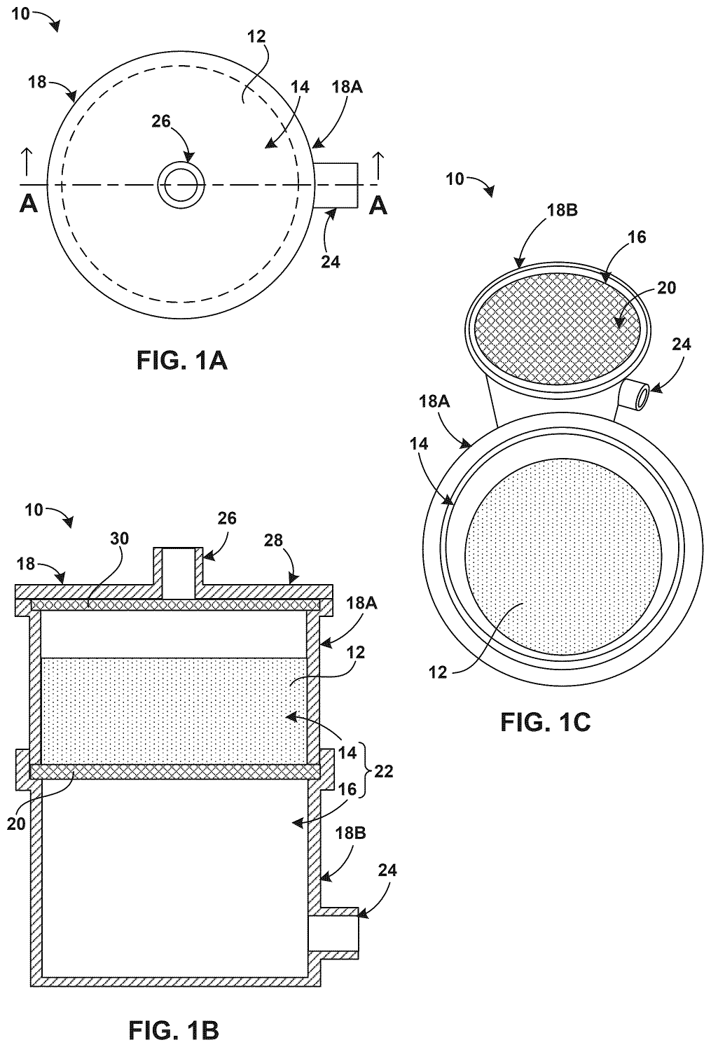

FIG. 1A is a conceptual diagram illustrating a top view of an exhaust trap 10 for a vacuum furnace (not shown in FIG. 1A). Exhaust trap 10 is configured to filter an exhaust stream of the vacuum furnace. FIG. 1B is a conceptual diagram illustrating a cross-sectional view of exhaust trap 10 at line A-A including a filter medium 12 in a first chamber 14, and with no filter medium in a second chamber 16.

FIG. 1C is a conceptual diagram illustrating a disassembled configuration of exhaust trap 10 with first chamber 14 separated from second chamber 16. Housing 18 may have any suitable shape or cross-section, for example, having a polygonal or curved periphery or contour. In some examples, housing 18 is substantially cylindrical. Housing 18, first housing portion 18A, or second housing portion 18B, may include any suitable composition, for example, a metal, an alloy, a glass, or a ceramic, or combinations thereof. Housing 18 is impervious to the exhaust stream, such that the exhaust stream is constrained to flow through housing 18. First chamber 14 may be defined by an upper portion of housing 18 relative to a direction of gravity, and second chamber 16 may be defined by a lower portion of housing 18 relative to the direction of gravity.

Filter medium 12 is configured to filter the exhaust stream. Filter medium 12 may include any suitable filter structure, for example, one or more of a woven material, a non-woven material, a batting, a mesh, a fabric, a foam, a filter bed, beads, particulates, or combinations thereof. Filter medium 12 may include any suitable filter composition capable of sustaining a temperature of the exhaust stream, for example, an inorganic filter. In some examples, filter medium 12 includes fiberglass. Filter medium 12 may define a substantially constant density (e.g., bulk density), or exhibit a density gradient. In some examples, filter medium 12 defines a gradient density along a length of housing 18, for example, a decreasing porosity or increasing density along a length of housing 18.

Exhaust trap 10 may include a housing 18 and a media barrier 20. Housing 18 defines an interior 22. Media barrier 20 may divide interior 22 of housing 18 into first chamber 14 and second chamber 16. For example, housing 18 may include a first housing portion 18A defining first chamber 14, and a second housing portion 18B defining second chamber 16, with media barrier 20 between first chamber 14 and second chamber 16. In some examples, as shown in FIGS. 1A to 1C, first housing portion 18A is removable or separable from second housing portion 18B. Thus, first chamber 14 may be removably secured to second chamber 16. In some examples, exhaust trap 10 includes a gasket between first housing portion 18A and second housing portion 18B. In other examples, housing 18 is integral, and first housing portion 18A is integral or unitary with second housing portion 18B.

Media barrier 20 is configured to allow the exhaust stream to flow from first chamber 14 to second chamber 16. For example, media barrier 20 may include a mesh, a screen, a perforated plate, or a structure defining a plurality of openings. Further, media barrier 20 may be configured to support filter medium 12 against gravity, or otherwise retain filter medium 12 in a predetermined position in first chamber 14, and away from second chamber 16.

Media barrier 20 may be retained at or near a bottom of first housing portion 18A, at or near a top of second housing portion 18B, or otherwise at a suitable position along housing 18. In some examples, housing 18, first housing portion 18A, or second housing portion 18B includes or defines a flange, a rim, a channel, or some other structure configured to support or retain media barrier at a predetermined position in housing 18. In some examples, exhaust trap 10 includes one or more clips or fasteners to secure media barrier 20 in housing 18.

Exhaust trap 10 may further include a trap outlet 24 fluidically coupled to second chamber 16, where media barrier 20 is between filter medium 12 and trap outlet 24. In some examples, as shown in FIG. 1B, trap outlet 24 is integral with second housing portion 18B. In other examples, trap outlet 24 is secured to second housing portion 18B. Trap outlet 24 may be offset upward from a bottom of second housing portion 18B (or from a bottom of second chamber 16) relative to a direction of gravity, for example, to permit accumulation of liquified byproduct below the level of trap outlet 24 within second chamber 16 and without entering trap outlet 24. In other examples, trap outlet 24 may be located at a bottom of second chamber 16 and covered by an inverted funnel or shield and/or an outlet wall within chamber 16 to shield trap outlet 24 from entry of liquified byproduct.

Exhaust trap 10 may further include a trap inlet 26 fluidically coupled to first chamber 14, where filter medium 12 is between trap inlet 26 and media barrier 20. In some examples, as shown in FIG. 1B, trap inlet 26 is integral with a lid 28 covering first housing portion 18A, or otherwise at a top of first housing portion 18A. In other examples, trap inlet 26 is secured to first housing portion 18A, or positioned offset from the top of first housing portion 18A. Regardless of the position, trap inlet 26 is configured to be fluidically coupled to an exhaust of the vacuum furnace to receive at least a portion of the exhaust stream generated by the vacuum furnace. Trap inlet 26 may be positioned substantially symmetrically centered across a width of exhaust trap 10, for example, to promote an even distribution of the exhaust stream through chamber 14 and across filter medium 12.

In some examples, exhaust trap 10 includes more than one media barrier. For example, media barrier 20 may be a first media barrier, and exhaust trap 10 may include a second media barrier 30 being the same as or different from first media barrier in one or more of structure, composition, or geometry. In some examples, first chamber 14 includes second media barrier 30, and filter medium 12 is positioned between first media barrier 20 and second media barrier 30. In some such examples, second media barrier 30 is positioned between trap inlet 26 and filter medium 12. In some examples, second media barrier 30 is spaced from filter medium 12. In other examples, second media barrier 30 contacts filter medium 12, such that filter medium 12 is held between opposing first media barrier 20 and second media barrier 30.

The exhaust stream may be introduced into first chamber 14 (e.g., via trap inlet 26), flow through filter medium 12 and media barrier 20 into second chamber 16, and be discharged from second chamber 16 (e.g., via trap outlet 24). Thus, liquified byproducts or contaminants from the exhaust stream separated or extracted by filter medium 12 or otherwise separating from the exhaust stream, may depart filter medium 12 or first chamber 14 and travel to and accumulate in second chamber 16, such that filter medium 12 or exhaust trap 10 as a whole does not exhibit clogging, or at least permits the exhaust stream to continue discharging from the exhaust trap 10.

In course of operation, one or more of filter medium 12, first media barrier 20, or second media barrier 30 may be removable from and/or replaceable into exhaust trap 10, for example, for inspection, maintenance, cleaning, or reuse.

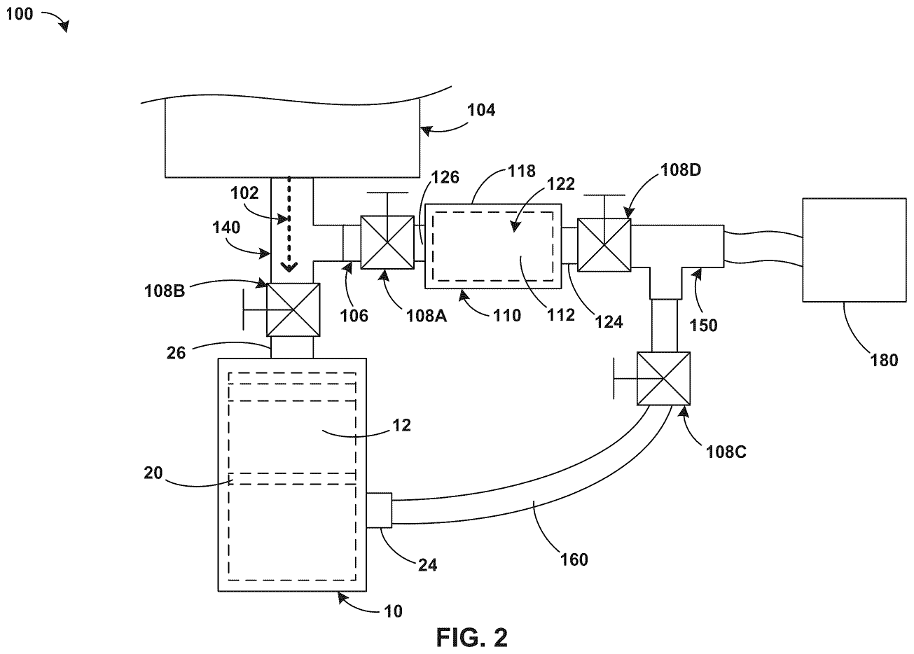

FIG. 2 is a conceptual diagram illustrating a system 100 configured to filter an exhaust stream 102 of a vacuum furnace 104 and including exhaust trap 10 of FIG. 1A as a first exhaust trap, and a second exhaust trap 110 along a bypass line 106.

System 100 may be configured to filter exhaust stream 102 generated by vacuum furnace 102. System 100 may include exhaust trap 10 configured to receive at least a portion of exhaust from exhaust stream 102.

Filter medium 12 may be a first filter medium, and system 100 may further include a second filter medium 112 in second exhaust trap 110. System 100 may further include a valve 108A coupled to second exhaust trap 110 (e.g., to an inlet of second exhaust trap 110) and configured to bypass at least a portion of the exhaust from exhaust stream 102 through second exhaust trap 110.

While system 100 includes second exhaust trap 110 as shown in FIG. 2, in other examples, bypass line 106 may not include second exhaust trap 110. In examples in which system 100 includes second exhaust trap 110, housing 18 of first exhaust trap 10 may be a first housing, trap inlet 26 may be a first trap inlet, filter medium 12 may be a first filter medium, interior 22 may be a first interior, and trap outlet 24 may be a first trap outlet. In some such examples, first trap inlet 26 is configured to receive at least a first portion of exhaust from exhaust stream 102 into first interior 22. Media barrier 20 divides first interior 22 of first housing 18 into first chamber 14 and second chamber 16 and is configured to allow the first portion of exhaust stream 102 to flow from first chamber 14 to second chamber 16. First filter medium 12 is configured to filter the first portion of exhaust stream 102 received in first chamber 14. No filter medium is present in second chamber 16. First trap outlet 24 is configured to discharge a first filtered stream from first exhaust trap 10.

Second exhaust trap 110 may include a second housing 118, a second trap inlet 126, second filter medium 112, and a second trap outlet 124. Second housing 118 may define a second interior 122. Second trap inlet 126 is configured to receive at least a second portion of exhaust from exhaust stream 102 into second interior 122. Second filter medium 112 is configured to filter the second portion of exhaust stream 102 received in second interior 122. One or more of the structure, composition, or shape of second filter medium 112 may be the same or different from that of first filter medium 12. Second trap outlet 124 is configured to discharge a second filtered stream from second exhaust trap 110. Valve 108A is coupled to second exhaust trap 110 and configured to bypass at least the second portion of the exhaust from exhaust stream 102 through second exhaust trap 110.

While second exhaust trap 110 differs from first exhaust trap 10 in the example of system 100 shown in FIG. 2, in other examples, second exhaust trap 110 may be similar or identical to first exhaust trap 10 in one or more of construction, size, shape, geometry, positioning of filter medium, number of housings, or overall operation. In some examples, second housing 118 of exhaust trap 110 includes a single housing portion, or otherwise a single chamber housing second filter medium 112. In other examples, second housing 118 of exhaust trap 110 may include a first housing portion and a second housing portion, with the first housing portion housing second filter medium 112 and the second housing portion being absent filter medium (e.g., similar in positioning of filter medium to first exhaust trap 10).

System 100 may further include an inlet joint 140. Inlet joint 140 may define an inlet configured to receive exhaust stream 102 from vacuum furnace 104, a first outlet fluidically coupled to first exhaust trap 10, and a second outlet fluidically coupled to second exhaust trap 110 through valve 108A. Inlet joint 140 may be any suitable joint, for example, a T-joint, a Y-joint, or any other joint. In some examples, system 100 includes an outlet joint 150. Outlet joint 150 may define a first inlet fluidically coupled to first trap outlet 24, and a second inlet fluidically coupled to second trap outlet 124.

In some examples, system 100 includes valves in addition to valve 108A. For example, system 100 may include a first inlet valve 108B fluidically coupled to first trap inlet 26, second inlet valve (e.g., valve 108A) fluidically coupled to second trap inlet 126, a first outlet valve 108C fluidically coupled to first trap outlet 24, and a second outlet valve 108D fluidically coupled to second trap outlet 124.

System 100 may further include an outlet bypass line 160 fluidically coupling first trap outlet 24 to second trap outlet 124, outlet bypass line 160 being configured to bypass second exhaust trap 110. In some examples, bypass line 160 is a first bypass line, and system 100 further includes a second bypass line (not shown in FIG. 2) fluidically coupling first trap inlet 26 to second trap outlet 124, the second bypass line being configured to bypass first exhaust trap 10 and second exhaust trap 110.

System 100 ultimately reduces or prevents byproducts (e.g., liquified fractions, components, or contaminants of exhaust stream 102) from entering a component 180 that is downstream of vacuum furnace 104. In some examples, component 180 includes a vacuum pump.

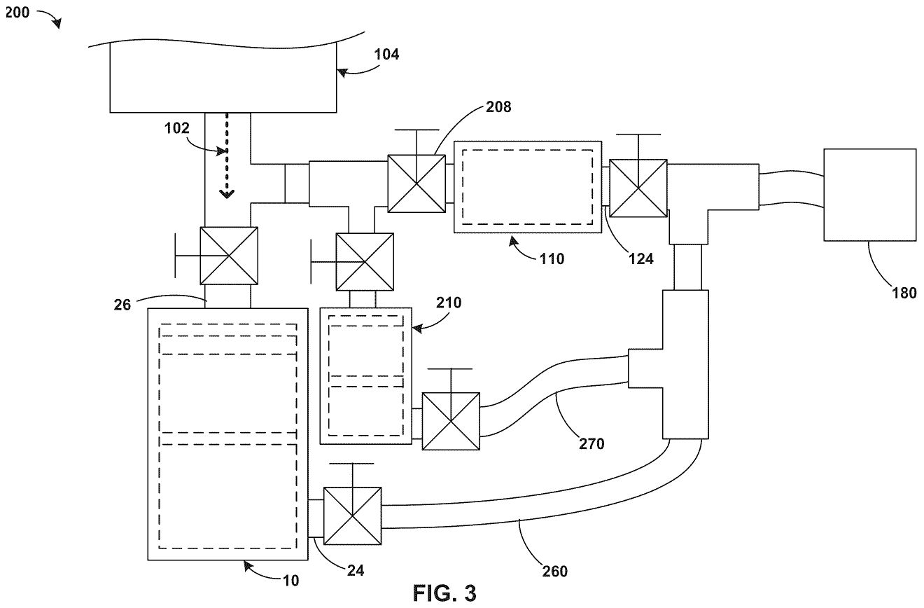

FIG. 3 is a conceptual diagram illustrating a system 200 configured to filter an exhaust stream 102 of vacuum furnace 104 and including first exhaust trap 10 (e.g., described with reference to FIG. 1), second exhaust trap 110 (e.g., described with reference to FIG. 1), and a third exhaust trap 210. Third exhaust trap 210 may be substantially similar to first exhaust trap 10 in structure and operation, for example, including two chambers with a filter medium in only one of the two chambers. In the example shown in FIG. 3, third exhaust trap 210 has a smaller interior volume than first exhaust trap 10. In other examples, third exhaust trap 210 is identical to first exhaust trap 10.

System 200 includes outlet bypass line 260 fluidically coupling first trap outlet 24 to second trap outlet 124. Outlet bypass line 260 may be a first bypass line, and third exhaust trap 210 may be positioned along a second bypass line 270 extending between first trap inlet 26 and second trap outlet 124. For example, second bypass line 270 may be used to bypass first exhaust trap 10 and/or second exhaust trap 110 (e.g., if one or both of first exhaust trap 10 or second exhaust trap 110 are at or near capacity or exhibiting pressures indicative of blockage or initiation of blockage).

System 200 includes a plurality of valves 208. Plurality of valves 208 may include respective valves fluidically coupled to respective inlets and outlets of first exhaust trap 10, second exhaust trap 110, or third exhaust trap 210. Plurality of valves 208 may be manually operable or automatically operable (e.g., by processing circuitry) in response to process conditions in system 200, for example, presence or absence of blockage or initiation of blockage in one or more of first exhaust trap 10, second exhaust trap 110, or third exhaust trap 210.

In some examples, system 200 may include second bypass line 270, but be absent of third exhaust trap 210. For example, second bypass line 270 may function as an unfiltered or emergency bypass or vent in cases where first exhaust trap 10 and second exhaust trap 110 are blocked or exhibit initiation of blockage.

The following enumerated clauses describe various examples according to the present disclosure.

Clause 1: An exhaust trap configured to filter an exhaust stream of a vacuum furnace, the exhaust trap including: a housing defining an interior; a media barrier dividing the interior of the housing into a first chamber and a second chamber and configured to allow the exhaust stream to flow from the first chamber to the second chamber; and a filter medium in the first chamber and configured to filter the exhaust stream, where no filter medium is present in the second chamber.

Clause 2: The exhaust trap of clause 1, where the media barrier includes a mesh.

Clause 3: The exhaust trap of clause 1 or 2, further including a trap outlet fluidically coupled to the second chamber, where the media barrier is between the filter medium and the trap outlet.

Clause 4: The exhaust trap of any of clauses 1 to 3, further including a trap inlet fluidically coupled to the first chamber, where the filter medium is between the trap inlet and the media barrier.

Clause 5: The exhaust trap of clause 4, where the media barrier is a first media barrier, where the first chamber includes a second media barrier, and where the filter medium is positioned between the first media barrier and the second media barrier.

Clause 6: The exhaust trap of clause 5, where the second media barrier is positioned between the trap inlet and the filter medium.

Clause 7: The exhaust trap of any of clauses 1 to 6, where the housing is substantially cylindrical, where the first chamber is defined by an upper portion of the housing relative to a direction of gravity, and where the second chamber is defined by a lower portion of the housing relative to the direction of gravity.

Clause 8: The exhaust trap of any of clauses 1 to 8, where the first chamber is removably secured to the second chamber.

Clause 9. A system configured to filter an exhaust stream of a vacuum furnace, the system including: a first exhaust trap including: a first housing defining a first interior; a first trap inlet configured to receive at least a first portion of exhaust from the exhaust stream into the first interior; a media barrier dividing the interior of the first housing into a first chamber and a second chamber and configured to allow the exhaust stream to flow from the first chamber to the second chamber; a first filter medium configured to filter the first portion of the exhaust stream received in the first chamber, no filter medium being present in the second chamber; and a first trap outlet configured to discharge a first filtered stream from the first exhaust trap; a second exhaust trap including: a second housing defining a second interior; a second trap inlet configured to receive at least a second portion of exhaust from the exhaust stream into the second interior; a second filter medium configured to filter the second portion of the exhaust stream received in the second interior; and a second trap outlet configured to discharge a second filtered stream from the second exhaust trap; and a valve coupled to the second exhaust trap and configured to bypass at least the second portion of the exhaust from the exhaust stream through the second exhaust trap.

Clause 10: The system of clause 9, further including an inlet joint, the inlet joint defining: an inlet configured to receive the exhaust stream from the vacuum furnace; a first outlet fluidically coupled to the first exhaust trap; and a second outlet fluidically coupled to the second exhaust trap through the valve.

Clause 11: The system of clause 9 or 10, further including an outlet joint, the outlet joint defining: a first inlet fluidically coupled to the first trap outlet; and a second inlet fluidically coupled to the second trap outlet.

Clause 12: The system of any of clauses 9 to 11, further including: a first inlet valve fluidically coupled to the first trap inlet; a second inlet valve fluidically coupled to the second trap inlet; a first outlet valve fluidically coupled to the first trap outlet; and a second outlet valve fluidically coupled to the second trap outlet.

Clause 13: The system of any of clauses 9 to 12, further including an outlet bypass line fluidically coupling the first trap outlet to the second trap outlet, the outlet bypass line being configured to bypass the second exhaust trap.

Clause 14: The system of clause 13, where the outlet bypass line is a first bypass line, the system further including a second bypass line fluidically coupling the first trap inlet to the second trap outlet, the second bypass line being configured to bypass the first exhaust trap and the second exhaust trap.

Clause 15: The system of clause 14, further including a third exhaust trap between the first trap inlet and the second bypass line.

Various examples have been described. These and other examples are within the scope of the following claims.

What is claimed is:

1. An exhaust trap configured to filter an exhaust stream of a vacuum furnace, the exhaust trap comprising:
a housing defining an interior;
a media barrier dividing the interior of the housing into a first chamber and a second chamber and configured to allow the exhaust stream to flow from the first chamber to the second chamber; and
a filter medium in the first chamber and configured to filter the exhaust stream,
wherein no filter medium is present in the second chamber.

2. The exhaust trap of claim 1, wherein the media barrier comprises a mesh.

3. The exhaust trap of claim 1, further comprising a trap outlet fluidically coupled to the second chamber, wherein the media barrier is between the filter medium and the trap outlet.

4. The exhaust trap of claim 1, further comprising a trap inlet fluidically coupled to the first chamber, wherein the filter medium is between the trap inlet and the media barrier.

5. The exhaust trap of claim 4, wherein the media barrier is a first media barrier, wherein the first chamber comprises a second media barrier, and wherein the filter medium is positioned between the first media barrier and the second media barrier.

6. The exhaust trap of claim 5, wherein the second media barrier is positioned between the trap inlet and the filter medium.

7. The exhaust trap of claim 1, wherein the housing is substantially cylindrical, wherein the first chamber is defined by an upper portion of the housing relative to a direction of gravity, and wherein the second chamber is defined by a lower portion of the housing relative to the direction of gravity.

8. The exhaust trap of claim 1, wherein the first chamber is removably secured to the second chamber.

9. A system configured to filter an exhaust stream of a vacuum furnace, the system comprising:
a first exhaust trap comprising:
a first housing defining a first interior;
a first trap inlet configured to receive at least a first portion of exhaust from the exhaust stream into the first interior;
a media barrier dividing the interior of the first housing into a first chamber and a second chamber and configured to allow the exhaust stream to flow from the first chamber to the second chamber;
a first filter medium configured to filter the first portion of the exhaust stream received in the first chamber, no filter medium being present in the second chamber; and
a first trap outlet configured to discharge a first filtered stream from the first exhaust trap;
a second exhaust trap comprising:
a second housing defining a second interior;
a second trap inlet configured to receive at least a second portion of exhaust from the exhaust stream into the second interior;
a second filter medium configured to filter the second portion of the exhaust stream received in the second interior; and
a second trap outlet configured to discharge a second filtered stream from the second exhaust trap; and
a valve coupled to the second exhaust trap and configured to bypass at least the second portion of the exhaust from the exhaust stream through the second exhaust trap.

10. The system of claim 9, further comprising an inlet joint, the inlet joint defining:
an inlet configured to receive the exhaust stream from the vacuum furnace;
a first outlet fluidically coupled to the first exhaust trap; and
a second outlet fluidically coupled to the second exhaust trap through the valve.

11. The system of claim 9, further comprising an outlet joint, the outlet joint defining:
a first inlet fluidically coupled to the first trap outlet; and
a second inlet fluidically coupled to the second trap outlet.

12. The system of claim 9, further comprising:
a first inlet valve fluidically coupled to the first trap inlet;
a second inlet valve fluidically coupled to the second trap inlet;
a first outlet valve fluidically coupled to the first trap outlet; and
a second outlet valve fluidically coupled to the second trap outlet.

13. The system of claim 9, further comprising an outlet bypass line fluidically coupling the first trap outlet to the second trap outlet, the outlet bypass line being configured to bypass the second exhaust trap.

14. The system of claim 13, wherein the outlet bypass line is a first bypass line, the system further comprising a second bypass line fluidically coupling the first trap inlet to the second trap outlet, the second bypass line being configured to bypass the first exhaust trap and the second exhaust trap.

15. The system of claim 14, further comprising a third exhaust trap between the first trap inlet and the second bypass line.
